(19) United States
(12) Patent Application Publication
(10) Pub. No.: US 2015/0355487 A1
(43) Pub. Date: Dec. 10, 2015

(54) OPTIMIZED LCD DESIGN PROVIDING ROUND DISPLAY MODULE WITH MAXIMIZED ACTIVE AREA

(71) Applicant: Google Technology Holdings LLC, Mountain View, CA (US)

(72) Inventors: Steve C. Emmert, McHenry, IL (US); Thomas E. Gitzinger, Libertyville, IL (US); John W. Kaehler, Mundelein, IL (US)

(21) Appl. No.: 14/461,971

(22) Filed: Aug. 18, 2014

Related U.S. Application Data
(60) Provisional application No. 62/009,160, filed on Jun. 6, 2014.

(51) Int. Cl. G02F 1/133

(52) U.S. Cl. CPC G02F 1/13306; G02F 2001/133388

(57) ABSTRACT

The display module is provided having a rounded shape in a matrix of pixels therein. A matrix of pixels is organized in rows and columns of pixels in a display area of the module such that a bottom pixel of each column is adjacent to a curved edge of the display area. In an inactive area outside the display area and adjacent to the bottom of the columns of pixels are a plurality of analog switch circuits configured to switch pixel signals to the columns of pixels. Additionally, a plurality of shift register circuits are positioned in the inactive area outside the display area and adjacent to the either ends of the rows of pixels. The plurality of shift register circuits are configured to shift signals to different rows of the pixels within the matrix.

### TECHNICAL FIELD

The following disclosure relates to Liquid Crystal Display (LCD) modules. More specifically, the present disclosure relates to round or elliptical LCDs display modules where the round or elliptical active display area has a narrow inactive area about its border such that the overall shape approximates a round or elliptical LCD display with a narrow bezel or border area.

### BACKGROUND

Traditionally, liquid crystal display (LCD) panels assume a generally rectangular row and column array of pixels, arranged in straight vertical columns and straight horizontal columns wherein each of the vertical columns have the same number of pixels and each of the horizontal columns have the same number of pixels. Analog switch circuits (ASWs) are typically integrated into the thin film transistor (TFT) backplane layout on the LCD glass, aligned side by side in one or more horizontal rows along the bottom of the display area to drive the vertical columns of the red, green, and blue (RGB) pixels. The ASWs serve as multiplexers used to take an output trace from the display driver IC to drive multiple columns of pixels, or rather sub pixels. For example, a 3 to 1 multiplexer (MUX) ASW takes one input signal from the display driver IC and provides three output signals to control the three sub pixels (red, green and blue) in one column of the display or active area. Using 6 to 1 MUX ASWs is also common. It is noted that 3 to 1 MUX ASWs and 6 to 1 MUX ASWs each have a block circuit footprint that has a length and width wherein the length is longer than the width. As stated, these ASWs are typically positioned on the bottom straight edge of the active area (i.e., the display area) of the display, between the active area and the driver IC. These ASWs are always positioned such that the length of the ASW block circuit is parallel with the columns of pixels in the active area.

The ASWs are required for high pixel density displays because they enable a fewer number of traces to be routed from the driver IC to the columns of pixels in the rectangular pixel matrix. If no multiplexer and ASWs are used, the space required to route all the traces to all the columns of pixels, along with the larger necessary size of the driver IC, would result in an unacceptable sacrifice to the size of the active area relative to the size of the inactive area about the border of the active area.

In a design of a round or oval LCD display for, for example, a smart watch, a round display module design is required. Ideally it would be advantageous for a round display module to have a completely round active area with a minimal border around the perimeter of the active area. It is recognized, however that a driver IC may have to be bonded to the glass, resulting in a truncated section of the otherwise round active area. The challenge is how to minimize the size of this truncated section in order to maximize the active area on the round display module.

An additional problem arises when trying to design a round display module when the analog switches are arranged in the traditional way, aligned side by side in one or more horizontal rows that extend below the entire width of the active area. The large width required to fit all the ASWs in a horizontal row presently requires either pushing the display module boundary outside the wanted round envelope of space as needed to enable a round product design, or it requires an unacceptable sacrifice to the size of the active area. A solution is needed to provide a round display module with a maximized active area for such an application.

### BRIEF DESCRIPTION OF THE DRAWINGS

For a more complete understanding, reference is now made to the following description taken in conjunction with the accompanying Drawings in which:

FIG. 1 is a drawing of a general layout for a LCD design of a round display module;

FIG. 2 is a drawing providing additional lay out detail for a LCD design of a round display module;

FIG. 3A is a drawing of a general layout for a LCD design of a round display module; and

FIG. 3B is a detailed block circuit diagram of a an enlarged portion of FIG. 3A.

### DETAILED DESCRIPTION

Referring now to the drawings, wherein like reference numbers are used herein to designate like elements throughout, the various views and embodiments of the optimized LCD design providing a round display module with a maximized active display area are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

It is understood that the use of specific component, device and/or parameter names, such as those used to indicate executing utility, logic or software described herein, are for example only and are not meant to imply any limitations on the described embodiments. Embodiments may be described with different nomenclature, terminology or acronyms utilized to describe the components, devices and parameters herein, without limitation. References to any specific protocol or proprietary name in describing one or more elements, features or concepts of the embodiments are provided solely as examples of one implementation, and such references do not limit the extension of the claimed embodiments to embodiments in which a different element, feature or concept name is utilized. Thus, each term utilized herein is to be given its broadest interpretation allowed based on the context in which that term is utilized.

As further described below, the implementation of functional features of the disclosure described may be provided within processing devices or structures, and can involve the use of a combination of hardware, firmware, as well as several software level constructs (e.g., program code) that are executed by a processor or controller device to provide a specific utility for the embodiment. The present features illustrate both hardware components and firmware/logic components within a display module.

Embodiments provide an LCD display module having a substantially circular, elliptical or other shape that have a boundary allowing for uninterrupted, contiguous rows and columns of pixels to be positioned therein. Analog switch circuits (ASWs) are integrated into the TFT backplane layout on the LCD glass. The ASWs are positioned outside and spaced along the border of the active display area such that each ASW is near to at least one end of one or more adjacent vertical columns of RGB pixels. Since, for example, the bottom RGB pixels (also referred to herein as “pixels”) of the vertical columns within a round LCD display cannot form a single row of pixels, embodiments position the ASWs adjacent to and spaced along the curved boundary of the active area such that each ASW is near to the bottom RGB pixels of at least one of the plurality of vertical columns. The ASWs serve as multiplexers that are used to take a single trace from a display driver integrated circuit (a controller circuit) and drive multiple columns of pixels.

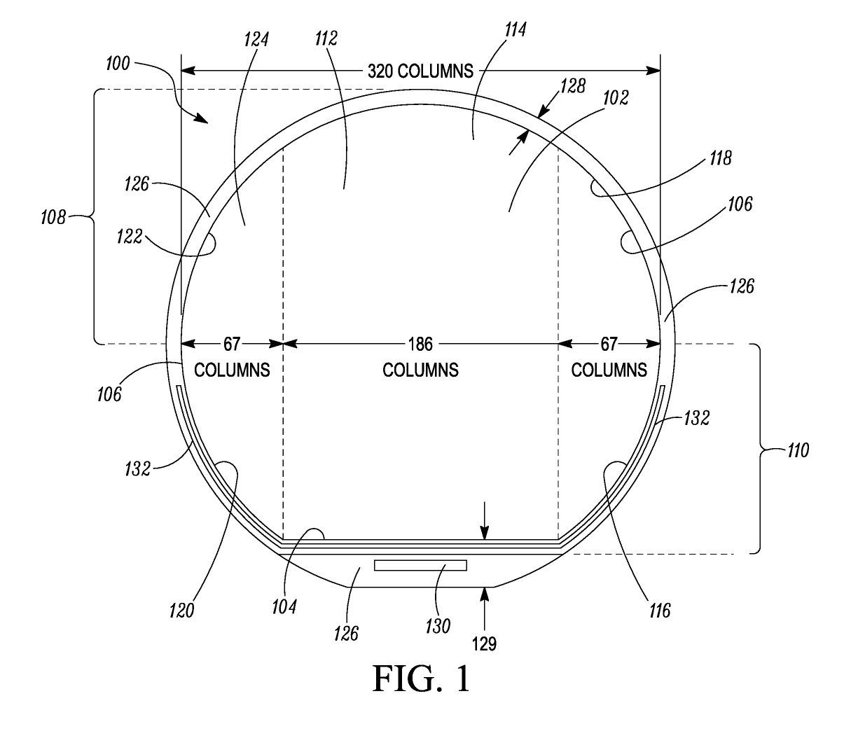

Referring now to FIG. 1, a general layout of a round LCD display module is depicted. The display module 100 has an active area 102 that is bounded at the bottom by a straight bottom edge 104 and bounded from both ends of the straight bottom edge 104 by a circular boundary 106. To simplify this description, consider the circular boundary 106 has been divided into two portions, and upper portion 108 and a lower portion 110. Within the active area 102 there is a matrix of pixels 112 (not specifically shown in this figure). In various embodiments each of the pixels in the matrix of pixels may comprise three sub pixels, being read, green and blue sub pixels (RGB pixels). The matrix of pixels 112 is comprised of contiguous rows and contiguous columns of pixels. In FIG. 1, this embodiment has a central plurality of contiguous columns of pixels 114 at each have a bottom pixel that is adjacent to the straight bottom edge 104 of the active area. In this embodiment, there are 186 contiguous columns of pixels in the central plurality of pixel columns 114.

To the right of the straight bottom edge boundary of the active area is a first curved lower side boundary edge 116. Between the right side end of the straight bottom edge 104 and the first curved lower side edge 116, there are a plurality of right side contiguous pixel columns that each extend from a location adjacent to the first curved lower side boundary edge 116 to a positioned adjacent to the first curved upper side boundary edge 118 of the active region. Similarly, on the left side of the straight bottom edge boundary 104 of the active area is a second curved lower side boundary edge 120. Between the left side of the straight bottom edge 104 and the second curved lower side edge 120, the left side plurality of contiguous pixel columns each extend from a location adjacent to the second curved lower side boundary edge 120 to a positioned adjacent to the second curved upper side boundary edge 122.

Outside of the active area boundary (i.e., outside of the display area) 102 is an inactive area 126. The inactive area 126 extends about the circular border 106 and in various embodiments can have a radial width 128 of from between about 1.1 mm to about 2 mm. The inactive area 126 also extends outside the straight bottom edge boundary 104 of the active area 102. Here the inactive area 126 can also have a width 129 of between about 1.1 mm to about 4 mm. In some embodiments, below the straight bottom edge 104 of the active area, the inactive area 128 may be from 1.1 mm to about 5 mm in order to accommodate a controller block circuit 130 that controls other circuitry and ultimately the display module 100. The controller block 130 in connected or is adaptable to be connected to circuitry external to the display module 100.

Within the inactive area 128 and along a portion of the first curved lower side boundary edge 116, straight bottom boundary edge 104, and the second curved lower boundary edge 120 are a plurality of analog switch circuit blocks 132 positioned to follow the contour of the active area boundary near the bottom of the vertical columns of pixels. In FIG. 1, the analog switch circuit blocks are shown as a solid line in order to simplify the figure. The analog switch circuit blocks will be described in more detail in the description of the following figures.

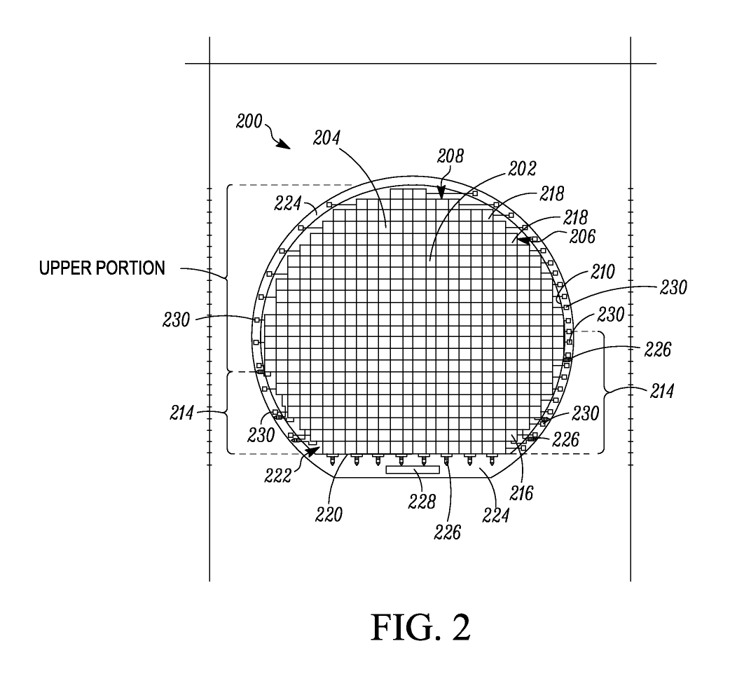

Referring now to FIG. 2, a more detailed example of a round display module 200 is shown. The active area 202 has a matrix of pixels 204 configured in a plurality of rows of pixels 206 and columns of pixels 208. The rows and columns of pixels are each unbroken, contiguous rows and columns of pixels. The boundary 210 about the active area 202 can be any shape that does not require that one of the rows or columns of pixels be noncontiguous or broken into two or more sections. In this example, each column of pixels 208 extends from a position within the active area 202 that is adjacent to the boundary 210 of the active area and along a lower portion 214 of the active area boundary 210. Each column of pixels 208 has a bottom pixel 216 and a top pixel 218. The combination of the bottom pixels 216 approximate the curvature of the curved portions of the boundary 210. Along the straight bottom edge boundary of the active area 220, the bottom pixels 216 of their respective plurality of contiguous columns of pixels form the bottom row of pixels 222.

An inactive area 224 extends a predetermined distance radially from the active area 202 outside of the boundary 210. The inactive area 224 contains control circuitry that provides data and switching signals to the pixels within the active area 202. In particular, the inactive area 224 has a plurality of analog switches (ASWs) 226 positioned adjacent to and spaced along the lower portion 214 of the boundary 210. Each analog switch circuit is connected to one or more different columns of pixels and is configured to control the three sub pixels (red, green and blue) within a column of pixels of the display. The ASWs 226 are positioned in the inactive area 224 to follow the edge of the lower portion 214 of the active area 202. The ASWs 226, in some embodiments, may be formed in a stairstep or somewhat stairstep formation along the curved portions of the boundary 210.

The ASWs serve as multiplexers, used to take one output trace (not specifically shown) from the display driver circuit IC 228 to drive multiple columns of pixels, or rather sub pixels. Here in FIGS. 2, 6 to 1 MUX ASWs are used to drive two columns of pixels wherein each pixel in a column comprises red, green and blue sub pixels. A single wire, not specifically shown, extends from the controller 228 to an ASW 226, which then effectively multiplexes the signal and provides two sets of three signals to two adjacent columns of pixels 208. Thus, in this embodiment each ASW 226 is effectively an analog switch block operating as a 6 to 1 multiplexer ASW (MUX ASW) configured to switch a multiplexed signal from a single input connection to six outputs that are electrically connected, in groups of three, to two different columns of pixels.

Additional embodiments can incorporate 3:1, 6:1, 9:1, 12:1 or 24:1 ASWs that take one output trace from the display driver IC 228 and multiplex the signal to drive multiple columns of pixels, or rather sub pixels within a plurality of columns of pixels.

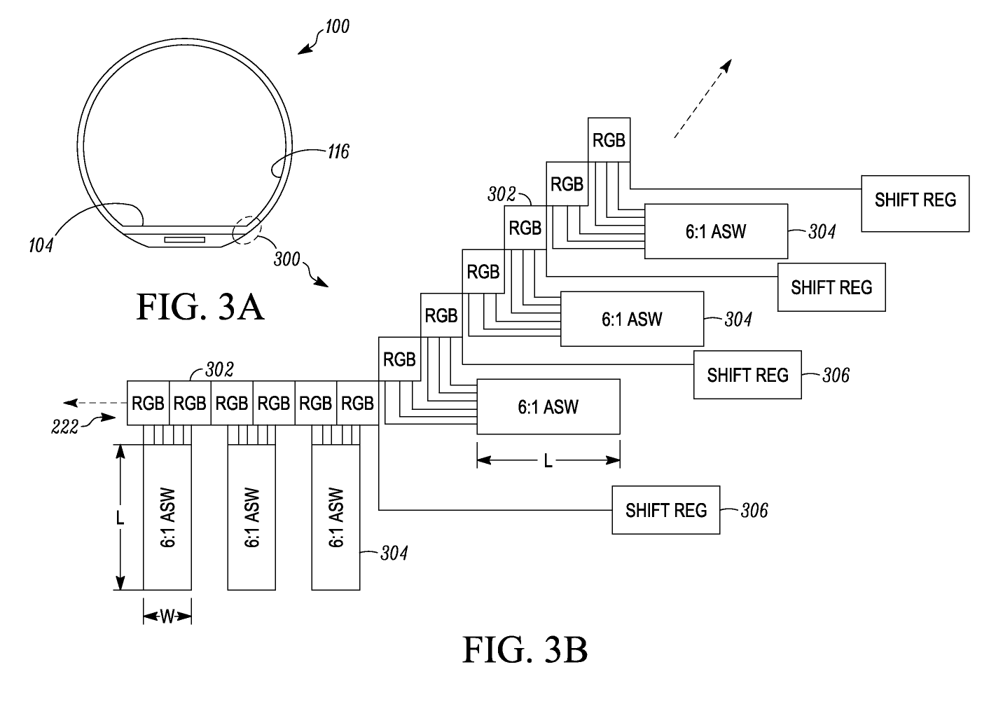

A 3:1 or larger ASW circuit block has a length and a width where the length is longer than the width. Although, it is difficult to see in FIG. 2, due to the drawn elements not being drawn to scale, it is advantageous for the ASWs circuit blocks 226 to be positioned along the curved portion of the boundary such that the length or long side of the ASW circuit blocks 226 is parallel with the horizontal pixel rows, and for the ASW circuit blocks 226 positioned along the straight bottom of the active area 222 be positioned such that the length or long side of the ASW circuit blocks 226 is parallel with the vertical pixel columns. This advantageous positioning of the ASW circuit blocks about the border will become clearer in the below description of FIG. 3.

Additionally, within the inactive area 224 there are a plurality of shift register circuits 230 that are configured to enable the latching of image data onto each one of the horizontal rows in a sequential manner in order to provide a horizontal raster of the display image. In some embodiments, the shift register circuits 230 are provided for every row of pixels 206 in a spaced manner along one side of the boundary 210 and within the inactive area. In other embodiments, the shift register circuits 230 are provided for every odd number row of pixels 206 in a spaced manner along one side of the boundary 210 as well as for every even-numbered row of pixels in a spaced manner along the other side of the boundary and within the interactive area. In yet another embodiment, the shift register circuits 230 are provided on both sides of the boundary 210 and for every row of pixels such that rastering of an image displayed on the display module 200 can be performed from either the top row to the bottom row of pixels or from the bottom row to the top row of pixels.

Referring now to FIGS. 3A and 3B, 3A depicts the general circuit layout drawing of the display module 100 with a lower right area 300 of the display module 100 circled. FIG. 3B is a magnified view of the circuit block diagram within area 300. The bottom pixel of a plurality of contiguous rows of pixels is shown. The bottom pixels along the straight bottom edge of the active area 104 form the bottom row of pixels 222. Each pixel 302 having red, green and blue sub pixels. As the active area boundary begins to curve upward on the right side of straight bottom edge portion of the boundary, the bottom pixels of each contiguous column of pixels take on a stair step formation. The ASWs 304 also begin to follow the curve of the circular portion 116 of the active area boundary. The ASWs 304 are 6:1 ASW circuit blocks that are shown to provide three signals to each of two columns of pixels for the three sub pixels within each pixel. The ASWs 304 that are along the straight bottom edge 104 of the active area are positioned such that the length L of the ASWs, which is longer than the width W of the ASWs, is parallel with the columns of pixels. Alternatively, the ASWs 304 positioned within the interactive area and along the curved lower boundary edge 116 are placed such that their length L is perpendicular to the columns of pixels. This is done in order to minimize the radial width of the inactive area required to contain the ASWs 304 and the shift register circuit blocks 306 along with their associated electrical connections and wiring without needing a multi-layered TFT backplane.

It is understood that the boundary shape of the active area could be completely circular when the straight bottom edge of the active area 104 is minimized to having a length of the shortest first bottom straight row of pixels that can be used to approximate the boundary edge.

It will be appreciated by those skilled in the art having the benefit of this disclosure that this optimized LCD design providing a round or circular display module with a maximized active area provides a substantially circular LCD display with a minimized dazzle or in active area about the active display area. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A display module comprising:
an active area comprising:
a first curved lower side edge; and
a matrix of pixels configured in a plurality of rows and columns, the matrix of pixels comprising a first plurality of columns each having a bottom pixel adjacent to the first curved lower side edge such that the bottom pixels approximate the curvature of the first curved lower side edge;
an inactive area adjacent to and outside of the first curved lower side edge of the active area, the inactive area comprising:
a first plurality of analog switch circuits positioned adjacent to and spaced along the first curved lower edge, each analog switch circuit configured to switch pixel signals to at least one column of the first plurality of columns; and
a first plurality of shift register circuits positioned adjacent to the first curved lower side edge, each shift register of the first plurality of shift register circuits configured to shift signals to a different row of a first set of the plurality of rows.

2. The display module of claim 1, wherein the active area further comprises:
a straight bottom edge that is contiguous with a first end of the first curved lower edge; and wherein the matrix of pixels further comprises a second plurality of columns each having a bottom pixel adjacent to the straight bottom edge such that the bottom pixels form a bottom row of pixels parallel to the straight bottom edge of the active area; and
wherein the inactive area is further adjacent to and outside of the straight bottom edge of the active area, the inactive further comprises:
a second plurality of analog switch circuits positioned near to and spaced along the straight bottom edge, each analog switch circuit configured to switch pixel signals to at least on column of the second plurality of columns.

3. The display module of claim 2, wherein each of the first and second plurality of analog switch circuits have a circuit block length that is longer than their circuit block width; wherein at least one of the first plurality of analog switches is positioned with its circuit block length being parallel with the plurality of rows; and wherein at least one of the second plurality of analog switches is positioned with its circuit block length being parallel with the plurality of columns.

4. The display module of claim 1, further comprising a second plurality of shift register circuits positioned distal from the first lower curved edge, each shift register of the second plurality of shift register circuits configured to shift signals to a different row of a second set of the plurality of rows.

5. The display module of claim 4, wherein the first and the second sets of the plurality of rows are the same set of the plurality of rows such that each of the first plurality of shift registers corresponds to each of the second plurality of shift registers at opposite ends of each row of the first set of the plurality of rows.

6. The display module of claim 1, wherein each of the pixels comprise three subpixels being a red subpixel, a blue subpixel and a green subpixel.

7. The display module of claim 1, wherein the active region further comprises:
a first curved upper side edge that is with the first curved lower side edge, and wherein each column of the first plurality of columns has a top pixel adjacent to the first curved upper side edge such that the top pixels approximate the curvature of the first curved upper side edge; and
wherein the inactive area is further adjacent to and outside of the first curved upper side edge, the inactive area further comprises:
a third plurality of shift register circuits positioned adjacent to the first curved upper side edge, each one of the third plurality of shift register circuits configured to shift signals to a different row of a third set of the plurality of rows.

8. The display module of claim 1, wherein the display module is a LCD display module.

9. A display module comprising:
an active area having a boundary on a bottom side by a bottom edge, on a lower right side by a first curved edge, and on a lower left side by a second curved edge; the active area comprising:
a matrix of pixels organized in rows and columns, the matrix of pixels comprising a right plurality of columns each having a bottom pixel adjacent to the first curved edge such that the bottom pixels of the first plurality of columns approximate the curvature of the first curved edge; a central plurality of columns each having a bottom pixel adjacent to the bottom edge; and a left plurality of columns each having a bottom pixel adjacent to the second curved edge such that the bottom pixels of the left plurality of columns approximate the curvature of the second curved edge; and
an inactive area outside of and adjacent to the boundary, the inactive area comprising:
a right side inactive area comprising a first plurality of analog switch circuits adjacent to and spaced along the first curved edge, each analog switch circuit configured to switch pixel signals to at least one column of the right plurality of columns;
a central inactive area comprising a second plurality of analog switch circuits adjacent to and spaced along the bottom edge, each analog switch circuit configured to switch pixel signals to at least one column of the central plurality of columns;
a left side inactive area comprising a third plurality of analog switch circuits adjacent to and spaced along the second curved edge, each analog switch configured to switch pixel signals to at least one column of the left plurality of columns;
a first plurality of shift register circuits within the right side inactive area and spaced along the first curved edge, the first plurality of shift register circuits configured to enable latching of data on a first selected row of pixels.

10. The display device of claim 9, further comprising a second plurality of shift registers within the left side inactive area and spaced along the second curved edge, the second plurality of shift register circuits configured to enable latching of data on a second row of pixels.

11. The display device of claim 10, wherein the first plurality of shift register circuits are configured to enable latching of data on the odd rows of pixels and the second plurality of shift register circuits are configured to enable latching of data on the even rows of pixels.

12. The display device of claim 10, wherein the first plurality of shift register circuits are configured to enable latching of data on every row of pixels for vertical rastering in a direction from the bottom of the active area to the top of the active area and wherein the second plurality of shift register circuits are configured to enable latching of data on every row of pixels for vertical rastering in a direction from the top of the active area to the bottom of the active area.

13. The display device of claim 9, wherein each of the analog switch circuits of the first plurality of analog switch circuits have a circuit length that is greater than their circuit width; and wherein the first plurality of analog switch circuits are positioned such that their length is in a same direction as the rows of pixels.

14. The display device of claim 13, wherein each of the analog switch circuits of the second plurality of analog switch circuits have a circuit length that is greater than their circuit width; and wherein the second plurality of analog switch circuit are positioned such that their length is a same direction as the columns of pixels.

15. The display device of claim 9, further comprising a display controller circuit block connected and configured to control the first, second and third pluralities of analog switch circuits and the first plurality of shift register circuits.

16. The display device of claim 9, wherein the bottom edge boundary on the bottom side is straight.

17. The display device of claim 9 wherein each pixel has a red subpixel, a green subpixel and a blue subpixel.

18. The display device of claim 9 wherein the boundary of the active area is generally outwardly concave.

19. A display module comprising:
an active area within a boundary, the boundary having a curved upper edge and a straight lower edge, the boundary further being divided into an upper boundary portion and a lower boundary portion, the active area comprising:
a matrix of pixels organized in rows and columns such that each column of pixels extends from a position adjacent the lower boundary portion to a position adjacent to the upper boundary portion and each column of pixels comprises a bottom pixel and a top pixel; and
an inactive area outside the boundary, the inactive area comprises:
a plurality of analog switch circuits positioned adjacent to and spaced along the lower portion of the boundary, each analog switch circuit connected to switch image data to a different column of pixels;
a plurality of shift register circuits configured to enable the latching of image data on predetermined rows of pixels, each of the plurality of shift registers being spaced along the boundary and adjacent to a first or a last pixel of each row of pixels in the matrix.

20. The display module of claim 19, further comprising a controller module positioned outside the straight lower edge of the boundary, the controller configured to control the plurality of analog switch circuits and the plurality of shift registers.

21. The display module of claim 19, wherein the curved upper edge is part of an arc of a circle.

22. The display module of claim 19, wherein the plurality of analog switch circuits are grouped in a plurality of analog switch blocks each analog switch block having a length longer than its width; and wherein the analog switch blocks adjacent to the curved upper edge are further positioned such that their length is perpendicular to the columns.
